(19) United States
(12) Patent Application Publication
(10) Pub. No.: US 2006/0003624 A1
(43) Pub. Date: Jan. 5, 2006

(54) Interposer structure and method

(76) Inventors: Richard M. Dow, Philadelphia, PA (US); Timothy W. Ellis, Green Bay, WI (US); Stephen J. Kryven, Langhorne, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/151,630

(22) Filed: Jun. 13, 2005

Related U.S. Application Data
(60) Provisional application No. 60/579,415, filed on Jun. 14, 2004.

(51) Int. Cl. H01R 13/58

(52) U.S. Cl. 439/456

(57) ABSTRACT

A structure comprises at least one layer of thermally conductive, electrically insulating fibers, rovings, strands or yarns having first and second major surfaces, and at least one electrically insulated and/or non-insulated conductive wire or strand woven with the thermally conductive fibers, rovings, strands or yarns so that the electrically insulated and/or non-insulated conductive wire or strand extends from the first major surface to the second major surface in a plurality of locations.

This application claims the benefit of U.S. Provisional Patent Application No. 60/579,415, filed Jun. 14, 2004.

### FIELD OF THE INVENTION

The present invention relates to semiconductor packaging structures and methods.

### BACKGROUND

FIG. 1 is a schematic diagram of a conventional high power semiconductor packaging structure. The current technology for high power semiconductor press pack diodes and thyristors utilizes high tolerance, machined metal plates typically made of Copper or Copper plated Molybdenum. These plates are in tight contact with the power device in order to most efficiently carry the heat and electrical current. As the devices are typically Silicon or Silicon Nitride, they are very brittle and, as such, the surface of the Copper interposer has to be machined very flat in order not to mechanically stress the device. In addition, to maintain good contact, high forces are required between the interposers and the device. This necessitates a massive package casing structure to contain the forces.

Another packaging structure and technique is described in U.S. Pat. No. 6,559,561, which is incorporated by reference in its entirety, as though fully set forth herein. That patent describes a process including first weaving a plurality of electrically non-conductive strands (e.g., fiberglass yarns) and at least one electrically conductive strand (e.g., a copper wire) to form a woven fabric. Upper and lower surfaces of the woven fabric thus formed are exposed. Next, the woven fabric is impregnated with a resin material to form an impregnated fabric and, thereafter, the impregnated fabric is cured to form a cured fabric. The upper and lower surfaces of the cured fabric are then planed. The planing of these surfaces segments the at least one electrically conductive strand and forms a PCB substrate.

An improved packaging structure is desired.

### BRIEF DESCRIPTION OF THE DRAWINGS

FIG. 1 is a schematic diagram of a conventional packaging structure.

FIG. 2 is an isometric view of an exemplary structure according to an embodiment of the invention.

FIG. 3 shows the structure of FIG. 2 being used to provide power to and remove heat from a device.

FIGS. 4A and 4B shows application of conductive plates to the structure of FIG. 2, for providing power more uniformly and removing heat more uniformly.

FIG. 5 shows another embodiment of a package.

FIGS. 6A-6I show steps of fabricating the structure of FIG. 5.

### DETAILED DESCRIPTION

U.S. Provisional Patent Application No. 60/579,415, filed Jun. 14, 2004 is incorporated by reference herein in its entirety as though fully set forth below.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,”etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

A structure and application of materials is disclosed herein, using a composite weaving technology that can separate thermal management from electronic power management.

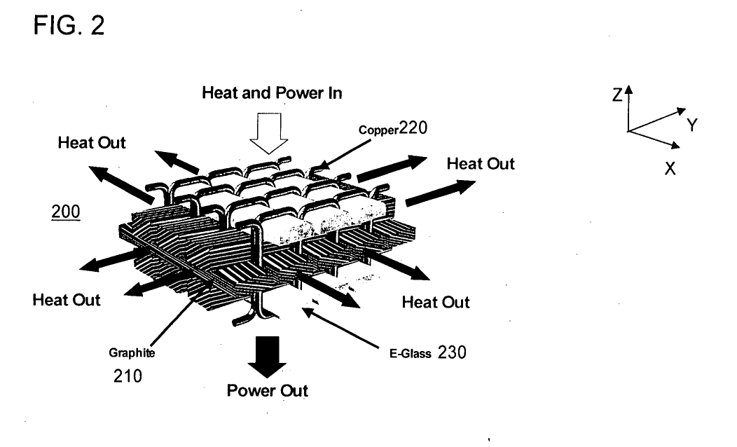

FIG. 2 shows an exemplary embodiment that separates thermal management from electronic power management. The structure 200 has a core of a compliant material 210 with a high thermal conductivity, and relatively low electrical conductivity. For example, graphite fibers, rovings, strands or yarn 210 may be used. Examples of alternative materials that could be substituted for graphite include but are not limited to aluminum Nitride, Silicon Carbide, Intrinsically Conductive Polymer. Pitch based graphite yarn has very high thermal conductivity and can be utilized for heat transfer. In some embodiments, a high thermal conductivity graphite of about 800 W/mK is used. The thermal and electrical properties of the material 210 are determined by the manufacturing process used. For example, in some embodiments, thermal conductivity may range from 1000 W/mK (Watts per meter Kelvin) to 8.5 W/mK with corresponding electrical resistivity of 1.3 mico ohms centimeters to 18 micro ohm centimeters. The total thickness of the thermally conductive core material 210 may vary, depending on the die thickness. For example, the graphite should have a minimum thickness approximately equal to the thickness of the semiconductor die and a maximum thickness of about 20 times the die thickness. As the amount of heat generated is directly proportional to the size of the die, the larger the die, the thicker the graphite required.

The layers of thermally conductive core yarns 210 may be individually woven layers or the fibers within an individual layer may not be woven to each other (except by the wire 220). In some embodiments, a plurality of layers of aligned graphite yarns may be provided, with alternating parallel planar layers oriented in orthogonal (X and Y) directions from each other.

The example of FIG. 2 shows three layers of graphite yarn 210, but any desired number of layers may be used. By running yarn in different layers in both X and Y directions, heat transfer in both directions is ensured without relying on extensive transverse heat transfer between adjacent parallel yarns.

Although FIG. 2 shows yarn layers that are not individually woven (except by the wire) to each other, alternatively, one or more individually woven layers of graphite fibers or yarns may be provided. These individually woven layers are then woven to each other by the wire 220.

A plurality of conductive, both insulated and/or non-insulated, (e.g., metal, such as copper) wires 220 are woven through the thermally conductive core layer 210. An example of a suitable conductor is copper having a resistivity of about 1.74 μohm-cm. Any weaving technique may be used, including but not limited to conventional weaving techniques. This weaving provides a plurality of insulated and/or non-insulated wires 220 extending in the Z direction, orthogonal to the plane of the thermally conductive core layers 210. If the thermally conductive core material 210 is woven, the insulated and/or non-insulated conductive wire 220 may replace strands in the weaving technique used, or the conductive strands may be in addition to the conventional weave. With the insulated and/or non-insulated conductive wire 220 woven into the material, the electrical power can flow from one side of the interposer 200 to the other (parallel to the Z axis). Although the exemplary wire material is copper, other insulated and/or non-insulated conductive materials, may be used such as, but not limited to, gold wire, aluminum wire, an electrically conductive polymer wire or a combination thereof.

With the wire 220 extending in the Z direction, the wires can contact the various fibers, strands or yarns 210 at several points along each fiber, strand or yarn, to conduct heat directly to the thermally conductive strands.

The diameter of the electrically insulated and/or non-insulated conductive wire 220 depends on the thickness of the structure 200 and the desired density of electrically conductive vias disposed therein. For example, the wire diameter may be between about 10 microns and about 500 microns and is preferably between about 15 microns and about 200 microns.

In some embodiments, one or more additional insulating layers 230 are provided on both sides of the core layers 210 for electrical isolation. For example, FIG. 2 shows a single layer of insulating fibers, rovings, strands or yarns 230 adjacent to each major face of the core thermally insulating layer 210. E-glass may be used for electrical isolation in some embodiments. Other examples of materials for the optional insulating layers 230 may include, for example, fiberglass, S-glass, polyester or other polymers, tetrafluoroethylene, “KEVLAR®”, Type 1064 Multi-End Roving and Hybon 2022 Roving available from PPG Industries. In other embodiments (not shown in FIG. 2) the insulating layers 230 may be omitted.

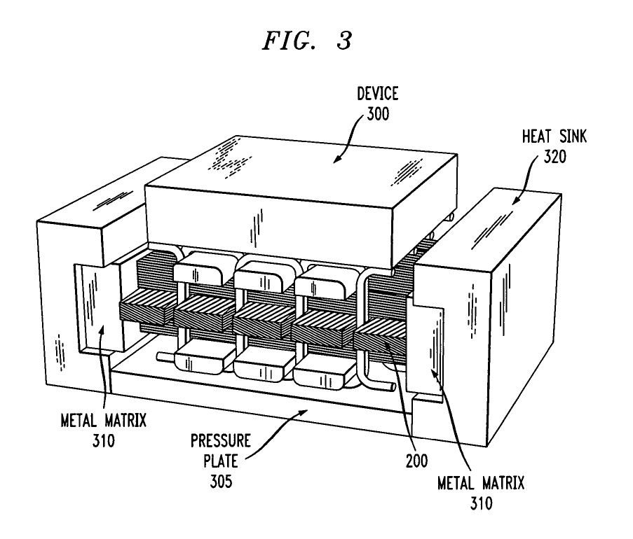

FIG. 3 shows a configuration in which the structure 200 described above is incorporated into a package for power and thermal management. A device 300 to be cooled and supplied with power is interfaced to one major face of the structure 200 of FIG. 2, and a pressure plate 305 is interfaced to the other major face. A metal matrix 310 is placed on each side of the structure, and a heat sink 320 is interfaced to the metal matrix. The metal-metal matrix 310 acts as a secondary heat sink of lower cost and/or higher mechanical stability than the graphite. These heat sinks 320 can be made of materials such as aluminum, aluminum/silicon carbide, copper, copper-tungsten, copper-molybdenum, aluminum-aluminum-nitride, for example. Although FIG. 3 only shows the metal matrix 310 and heat sink 320 on two sides of the structure 200, in other embodiments, the metal matrix and heat sink may be on three or more sides of the structure 200.

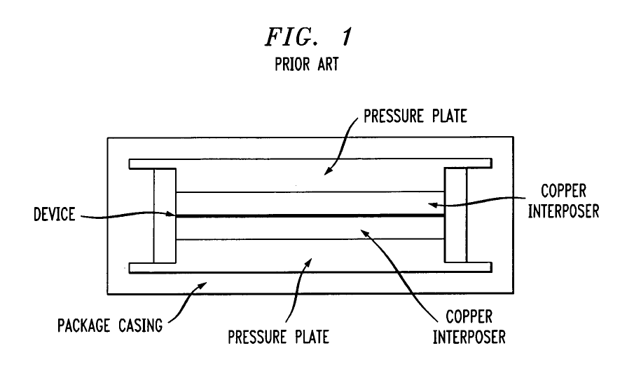

As shown in FIG. 3, by weaving the thermally conductive core material 210 (e.g., graphite) into the material and attaching the ends to a heat sink 320, the heat generated by the device can be flowed to the outside edges of the package (parallel to the X and Y axes), while allowing the electrical power to flow in the Z direction, through the thickness of the structure 200. Additionally, as stresses are built up due to thermal gradients and mismatches, the capability of fabric 210 to move in the bias direction allows the relief of these thermal stresses. The structure 200 shown in FIG. 2 is more capable of moving in the bias direction to relieve thermal stress than conventional structures such as that shown in FIG. 1.

Properties:

Thermal management is separated from electrical management by using a thermally conductive, electrically insulating material 210, such as graphite fibers.

Electrical management is separated from thermal management by using insulated and/or non-insulated conductive wire material 220.

Coefficient of thermal expansion mismatches are handled by the fact that woven material 210 is compliant in the bias direction and can yield to thermal stresses.

The accuracy of assembly is not required to be as critical for surface contact as prior art technology, because the contact points can “float”. For example, if a fiber, roving or yarn 210 moves longitudinally relative to one of the vertical portions of the wire 220, the fiber, roving or yarn 210 can still contact the wire 220 at a different point along the length of the fiber, roving or yarn 210.

There is no need to impregnate the structure 200 with any resin or adhesive, simplifying fabrication, and eliminating a curing step. Also, the absence of an impregnating resin or adhesive enhances the compliance and ability to accommodate coefficient of thermal expansion mismatches.

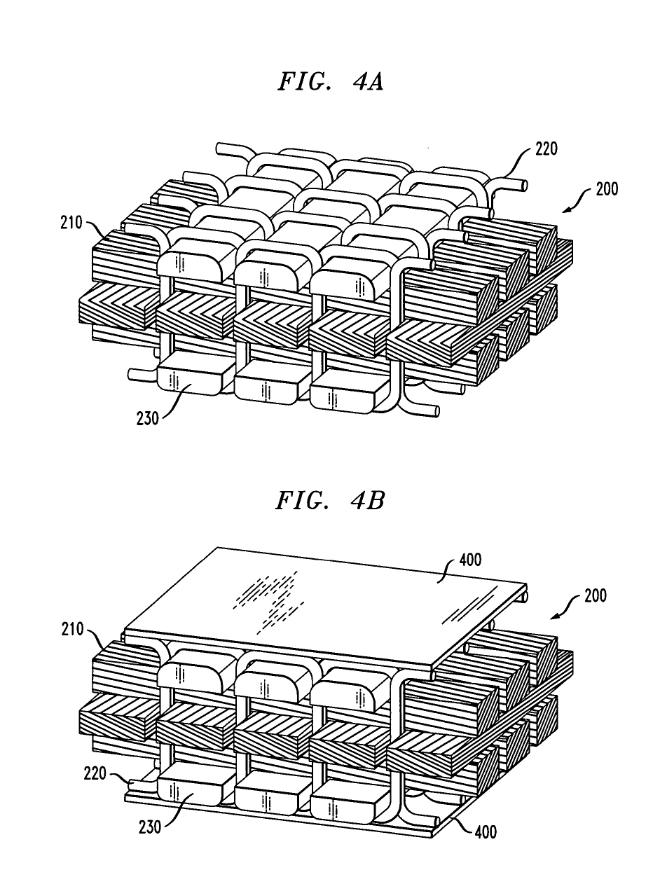

FIGS. 4A and 4B show application of a soldered plate 400 to the structure 200. The plate 400 may be formed of a highly conductive material, such as copper, for spreading heat and power across the length and width of the package. The plate 400 spreads the electrical power among the woven copper conductors 220.

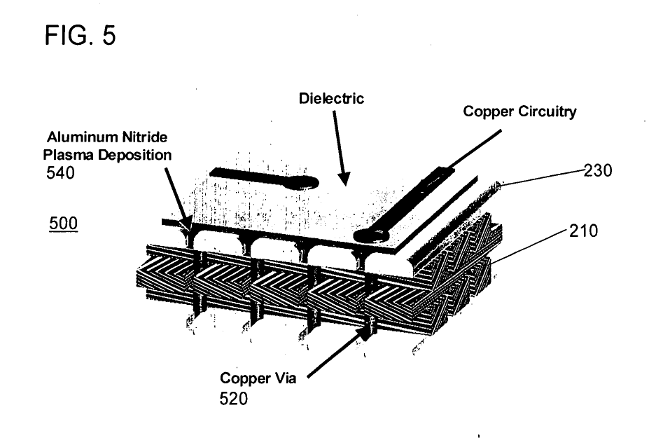

FIG. 5 shows another example, showing that it is also possible to fabricate circuitry on a non-resin impregnated substrate. Fabrication of the structure 500 begins with the structure 200 of FIG. 2. In the structure 500 of FIG. 5, the wires 220 are singulated to create vias 520. One can use laser, chemical etching, or mechanical cutting during the weaving operation, by utilizing a wire loom or other cutting means. After Aluminum Nitride 540 (or other suitable dielectric is plasma deposited the circuitry fabrication would be similar to current PCB practices. Several deposition processes may be used. For example, CVD (Chemical Vapor Deposition), Plasma arc spray, HVOF (High Velocity Oxygen Fueled) can be used depending on the material to be deposited Alternatives to the Aluminum Nitride 540 include materials such as Polyamide, Silicon Dioxide, Aluminum Oxide, Glass Silica, Liquid crystal polymers

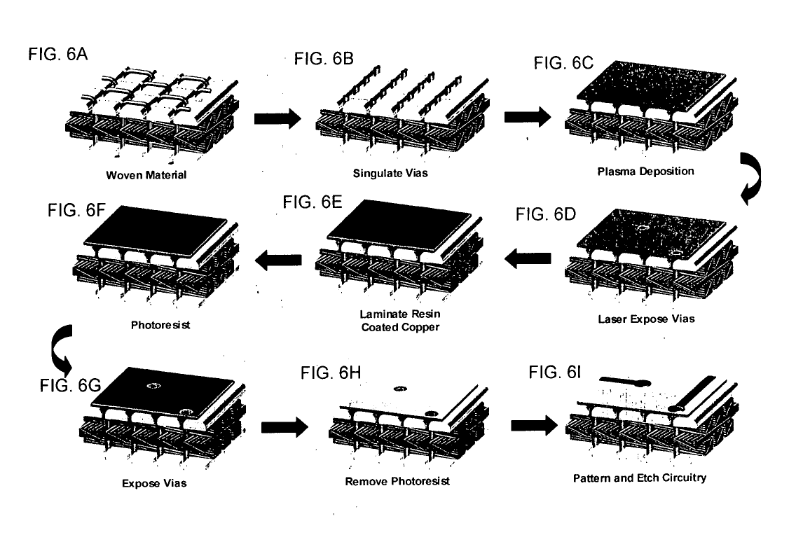

FIGS. 6A-6I show a process flow for this method.

In FIG. 6A, the structure 200 of FIG. 2 is fabricated.

FIG. 6B shows the structure after singulation of the wires 220 to form vias 520.

FIG. 6C shows the structure after plasma deposition of aluminum nitride (or other) dielectric.

FIG. 6D shows the structure after the vias 520 have been exposed, for example by laser etching.

In FIG. 6E, the entire surface is coated with a layer of metal (e.g., copper). The metal is then coated with a dielectric, such as a resin laminate.

In FIG. 6F, a photoresist is applied over the copper.

In FIG. 6G, the photoresist is selectively etched to expose the vias 520.

In FIG. 6H, the photoresist is removed, leaving the dielectric layer with exposed vias therebeneath.

In FIG. 6I, circuit patterns are formed over the dielectric, using any suitable deposition technique.

The structure 500 is useful, for example, for packaging Insulated Bipolar Gate Transistor (IBGT), because the same thermal and power problems exist as the diodes and thyristors but circuitry is also required. FIGS. 5 and 6I show an example with circuitry on the top surface (Similarly, circuitry on the bottom could be handled in the same manner.

### Summary of the Exemplary Embodiments

1. Some embodiments include a structure comprising:
(a) at least one layer of thermally conductive, electrically insulating fibers, rovings, strands or yarns having first and second major surfaces; and
(b) at least one electrically insulated and/or non-insulated conductive wire or strand woven with the thermally conductive fibers, rovings, strands or yarns so that the electrically insulated and/or non-insulated conductive wire or strand extends from the first major surface to the second major surface in a plurality of locations.

2. In some embodiments, the thermally conductive, electrically insulating fibers, rovings, strands or yarns comprise graphite.

3. Some embodiments have the thermally conductive, electrically insulating fibers, rovings, strands or yarns oriented in two directions that are perpendicular to each other.

4. In some embodiments, the at least one electrically insulated and/or non-insulated conductive wire or strand comprises one of the group consisting of copper, gold wire, aluminum wire, an electrically insulated and/or non-insulated conductive polymer wire or a combination thereof.

5. Some embodiments further comprise at least one layer of insulating fibers, rovings, strands or yarns facing a major surface of the layer of thermally conductive, electrically insulating fibers, rovings, strands or yarns, and woven thereto by the electrically insulated and/or non-insulated conductive wire or strand.

6. In some embodiments, the structure is interposed between a device and a pressure plate without impregnating the structure.

7. In some embodiments, the thermally conductive, electrically insulating fibers, rovings, strands or yarns are thermally coupled to a heat sink.

8. In some embodiments, a metal plate is joined to the electrically conductive wire or strand on at least one of the major surfaces.

9. In some embodiments, the electrically insulated and/or non-insulated conductive wire or strand is cut to form a plurality of vias.

10. Some embodiments further include a layer of dielectric disposed over the conductive wire or strand, and at least one printed circuit path formed over the layer of dielectric.

11. Some embodiments include a method comprising:
(a) providing at least one layer of thermally conductive, electrically insulating fibers, rovings, strands or yarns having first and second major surfaces; and
(b) weaving at least one electrically insulated and/or non-insulated conductive wire or strand with the thermally conductive fibers, rovings, strands or yarns so that the electrically insulated and/or non-insulated conductive wire or strand extends from the first major surface to the second major surface in a plurality of locations.

12. In some embodiments, the thermally conductive, electrically insulating fibers, rovings, strands or yarns comprise graphite.

13. In some embodiments the method includes orienting the thermally conductive, electrically insulating fibers, rovings, strands or yarns in two directions that are perpendicular to each other.

14. In some embodiments, the at least one electrically insulated and/or non-insulated conductive wire or strand comprises one of the group consisting of copper, gold wire, aluminum wire, an electrically insulated and/or non-insulated conductive polymer wire or a combination thereof.

15. Some embodiments further comprise weaving at least one layer of insulating fibers, rovings, strands or yarns onto a major surface of the layer of thermally conductive, electrically insulating fibers, rovings, strands or yarns, with the electrically conductive wire or strand.

16. Some embodiments include interposing the structure between a device and a pressure plate, for supplying power to and removing heat from the device.

17. Some embodiments include thermally coupling the thermally conductive, electrically insulating fibers, rovings, strands or yarns to a heat sink.

18. Some embodiments include joining a metal plate to the electrically insulated and/or non-insulated conductive wire or strand on at least one of the major surfaces.

19. Some embodiments include cutting the electrically insulated and/or non-insulated conductive wire or strand to form a plurality of vias.

20. Some embodiments further include forming a layer of dielectric over the insulated and/or non-insulated conductive wire or strand, and forming at least one printed circuit path over the layer of dielectric.

Although the invention has been described in terms of exemplary embodiments, it is not limited thereto. Rather, the invention should be construed broadly, to include other variants and embodiments, which may be made by those skilled in the art without departing from the scope and range of equivalents of the invention.

We claim:

1. A structure comprising:
(a) at least one layer of thermally conductive, electrically insulating fibers, rovings, strands or yarns having first and second major surfaces; and
(b) at least one electrically conductive wire or strand woven with the thermally conductive fibers, rovings, strands or yarns so that the electrically conductive wire or strand extends from the first major surface to the second major surface in a plurality of locations.

2. The structure of claim 1, wherein the at least one electrically conductive wire or strand includes an electrically insulated wire or strand and/or a non-insulated wire or strand.

3. The structure of claim 1, wherein the thermally conductive, electrically insulating fibers, rovings, strands or yarns comprise graphite.

4. The structure of claim 1, wherein the thermally conductive, electrically insulating fibers, rovings, strands or yarns are oriented in two directions that are perpendicular to each other.

5. The structure of claim 1, wherein the at least one electrically conductive wire or strand comprises one of the group consisting of copper, gold wire, aluminum wire, an electrically conductive polymer wire or a combination thereof.

6. The structure of claim 1, further comprising at least one layer of insulating fibers, rovings, strands or yarns facing a major surface of the layer of thermally conductive, electrically insulating fibers, rovings, strands or yarns, and woven thereto by the electrically conductive wire or strand.

7. The structure of claim 1, wherein the structure is interposed between a device and a pressure plate without impregnating the structure.

8. The structure of claim 1, wherein the thermally conductive, electrically insulating fibers, rovings, strands or yarns are thermally coupled to a heat sink.

9. The structure of claim 1, wherein a metal plate is joined to the electrically conductive wire or strand on at least one of the major surfaces.

10. The structure of claim 1, wherein the electrically conductive wire or strand is cut to form a plurality of vias.

11. The structure of claim 1, further including a layer of dielectric disposed over the conductive wire or strand, and at least one printed circuit path formed over the layer of dielectric.

12. A method comprising:
(a) providing at least one layer of thermally conductive, electrically insulating fibers, rovings, strands or yarns having first and second major surfaces; and
(b) weaving at least one electrically conductive wire or strand with the thermally conductive fibers, rovings, strands or yarns so that the electrically conductive wire or strand extends from the first major surface to the second major surface in a plurality of locations.

13. The method of claim 12, wherein the at least one electrically conductive wire or strand is electrically insulated and/or non-insulated.

14. The method of claim 12, wherein the thermally conductive, electrically insulating fibers, rovings, strands or yarns comprise graphite.

15. The method of claim 12, wherein the method includes orienting the thermally conductive, electrically insulating fibers, rovings, strands or yarns in two directions that are perpendicular to each other.

16. The method of claim 12, wherein the at least one electrically conductive wire or strand comprises one of the group consisting of copper, gold wire, aluminum wire, an electrically conductive polymer wire or a combination thereof.

17. The method of claim 12, further comprising weaving at least one layer of insulating fibers, rovings, strands or yarns onto a major surface of the layer of thermally conductive, electrically insulating fibers, rovings, strands or yarns, with the electrically conductive wire or strand.

18. The method of claim 12, further comprising interposing the structure between a device and a pressure plate, for supplying power to and removing heat from the device.

19. The method of claim 12, further comprising thermally coupling the thermally conductive, electrically insulating fibers, rovings, strands or yarns to a heat sink.

20. The method of claim 12, further comprising joining a metal plate to the electrically insulated and/or non-insulated conductive wire or strand on at least one of the major surfaces.

21. The method of claim 12, further comprising cutting the electrically conductive wire or strand to form a plurality of vias.

22. The method of claim 12, further comprising forming a layer of dielectric over the conductive wire or strand, and forming at least one printed circuit path over the layer of dielectric.
